(19) United States
(12) Patent Application Publication
(10) Pub. No.: US 2011/0052196 A1
(43) Pub. Date: Mar. 3, 2011

(54) Narrow-band DPSK apparatus, system, method

(76) Inventors: Alan H. Gnauck, Middletown, NJ (US); Chongjin Xie, Morganville, NJ (US)

(21) Appl. No.: 12/583,868

(22) Filed: Aug. 27, 2009

(51) Int. Cl. H04B 10/00; H04B 10/06; H04J 14/02

(52) U.S. Cl. 398/79; 398/202; 398/140

(57) ABSTRACT

System, apparatus and methods are provided for optical communication which tolerates the tight filtering effects from concatenation of reconfigurable optical add drop multiplexers (ROADMs). An exemplary system includes a receiver configured to receive a Narrow-Band Differential-Phase-Shift-Keyed (NB-DPSK) optical signal. The receiver includes a Delay Line Interferometer (DLI) with a path length difference of less than approximately one bit period and a detector for detecting DLI output to form an electrical signal. The bandwidth of the NB-DPSK optical signal is less than approximately one-half of a first bit rate of a transmitter from which the NB-DPSK optical signal is received. The electrical signal is processed to decode transmitted data. A corresponding transmitter amplifies a first input signal having a first bit rate; and drives a DPSK modulator after amplification to generate the NB-DPSK optical signal, which has a bandwidth less than approximately one-half of the first bit rate.

### FIELD OF THE INVENTION

The invention relates to optical transmission systems, and, in particular, to systems, apparatuses and techniques for use in optical transmission systems that include Reconfigurable Optical Add Drop Multiplexers (ROADMs).

### BACKGROUND INFORMATION

Optical networks are not only required to have high spectral efficiency, but are also required to be able to accommodate many reconfigurable optical add drop multiplexers (ROADMs). A ROADM permits channels to be added and dropped at the ROADM location in the optical network such that channels may be transmitted throughout the network from an originating location to a destination location. For example, 40-Gb/s signals may be required to be able to traverse a plurality of ROADMs in 50-GHz channel spacing Wavelength Division Multiplexing (WDM) systems in order to reach a desired destination. In such optical networks, the concatenation of ROADMs results in tight filtering effects. For example, each ROADM may be modeled as a filter and the concatenation of ROADMs in the optical network will reduce the effective bandwidth of the resultant concatenated filter.

In order to address these tight filtering effects, there are a few existing solutions. However, these existing solutions are less than optimal. One solution is to use optical duobinary, but optical duobinary has low sensitivity and poor nonlinear transmission performance. For example, in optical duobinary, receiver sensitivity is at best equal to that of a non-return-to zero (NRZ) on-off-keyed (OOK) signal. A second solution is to use partial Differential-Phase-Shift-Keyed (DPSK), but partial-DPSK is not cost effective. A third solution is to use coherent detection with high-level modulation, but this solution is not cost effective and also may have poor nonlinear transmission performance.

### SUMMARY

System, method and apparatus embodiments are provided that address tight filtering due to ROADMs concatenation with a new modulation format that is both efficient and cost effective. These embodiments relate to spectrally efficient modulation formats able to tolerate tight filtering effects due to concatenation of ROADMs in optical transmission systems.

An exemplary optical communication system includes a receiver configured to receive a Narrow-Band Differential-Phase-Shift-Keyed (NB-DPSK) optical signal, which is basically an amplitude modulated signal with phase information hidden therein. An exemplary receiver includes a Delay Line Interferometer (DLI), wherein a length difference between two paths of the DLI is less than approximately one bit period. The receiver may also include a detector configured to detect output of the DLI to form a corresponding electrical signal.

In one embodiment, the NB-DPSK optical signal has bandwidth less than approximately one-half of a first bit rate of a transmitter from which the NB-DPSK optical signal is received. In another embodiment, the NB-DPSK optical signal has bandwidth less than approximately one-quarter the first bit rate.

In one embodiment, the exemplary receiver includes a processor adapted to decode transmitted data from the corresponding electrical signal. The DLI may be a Partial Differential-Phase-Shift-Keyed (PDPSK) DLI, where a length difference between two of its paths is less than one bit period. The detector is a balanced detector in one receiver. For another receiver according to the invention, the detector is a single-ended detector.

The optical communication system may also include a transmitter that accepts a first input signal having a first bit rate R and has an amplifier configured to amplify the first input signal and a DPSK modulator configured to be driven by the first input signal after amplification to output the Narrow-Band DPSK optical signal. The transmitter may also include an electrical filter disposed to filter the first input signal before, after, or both before and after amplification. The NB-DPSK optical signal output has bandwidth less than approximately one-half of the first bit rate (R/2) in one embodiment. In another embodiment, the combined bandwidth of the amplifier, an optional electrical filter and the optical modulator is less than approximately one-half of the first bit rate (R/2). In one embodiment, the combined bandwidth of the combined amplifier, optional electrical filter and the optical modulator is less than approximately one-quarter of the first bit rate (R/4). In another embodiment, the bandwidth of the DPSK optical signal that is output is less than approximately one-quarter of the first bit rate (R/4). The transmitter may also include a continuous wave (CW) light source. The DPSK modulator may be further configured to receive CW light.

An exemplary method of optical communication includes receiving a Narrow-Band Differential-Phase-Shift-Keyed (NB-DPSK) optical signal at a Delay Line Interferometer (DLI) and detecting output of the DLI with a detector to form an electrical signal. The length difference between the two paths of the DLI is less than approximately one bit period. In one embodiment, the bandwidth of the NB-DPSK optical signal is less than approximately one-half of a first bit rate of a transmitter from which the NB-DPSK optical signal is received. In one embodiment, the NB-DPSK signal is generated by a transmitter with the electrical bandwidth less than approximately one-half of a first bit rate.

The method may further include processing the electrical signal to decode a transmitted data. Processing may include one or more of sampling the electrical signal, identifying a received symbol based on the sampled electrical signal and performing compensation on the sampled electrical signal to address nonlinearities in the received optical signal.

In an embodiment, the method may also include obtaining a first signal having a bit rate of R, amplifying the first signal by an amplifier and driving a modulator with the first signal after the amplifying so as to output the NB-DPSK optical signal. In such an embodiment, the NB-DPSK optical signal has a bandwidth of less than approximately R/2. The NB-DPSK optical signal may have a bandwidth of less than approximately R/4. In one embodiment, the combined bandwidth of the amplifier and the optical modulator is less than approximately R/2. The combined bandwidth of the amplifier, an optional electric filter and the optical modulator in the transmitter may be less than approximately R/4 in another embodiment.

The modulator may be a Mach-Zehnder Differential-Phase-Shift-Keyed DPSK) modulator. In a further embodiment, the modulator is biased at null. The amplified signal may also has a peak to peak voltage Vₚₚ=2 V_{π}, wherein V_{π} is a voltage that generates π phase shift between arms of the modulator.

In one embodiment, the method includes demultiplexing a Wavelength Division Multiplexed (WDM) optical signal to obtain a plurality of optical signals, at least one of the optical signals the Narrow-Band Differential-Phase-Shift-Keyed (NB-DPSK) optical signal. In another embodiment, the method includes multiplexing a plurality of output signals from a plurality of transmitters to generate a Wavelength Division Multiplexed (WDM) optical signal.

In one embodiment, an optical communication system comprises a Differential-Phase-Shift-Keyed (DPSK) receiver configured to detect a Narrow-Band Differential-Phase-Shift-Keyed (NB-DPSK) optical signal, the DPSK receiver including a DPSK demodulator having a path length difference between its two paths of less than approximately a bit period, the DPSK demodulator configured to demodulate the NB-DPSK optical signal. The optical communication system may also include a transmitter for accepting a first input signal having a first bit rate and having an amplifier configured to amplify the first input signal; and a DPSK modulator configured to be driven by the first input signal after amplification to output the Narrow-Band DPSK optical signal, the combined electrical bandwidth of the amplifier, an optional electrical filter and the optical modulator having bandwidth less than approximately one-half of the first bit rate.

Embodiments according to the invention are both efficient and cost effective. For example, an embodiment of a transmitter is cost effective, as it utilizes components with speed about half of the bit rate. In addition, the transmitter embodiment may reduce the bandwidth of the NB-DPSK signal in the electrical domain, and thus avoid optical filtering. Due to the narrow bandwidth of the transmitted signal, the penalty caused by the tight filtering from concatenation of ROADMs is small, so for instance, a 40-Gb/s Narrow-Band Differential-Phase-Shift-Keyed (NB-DPSK) can traverse (i.e., go though) many ROADMs in a WDM system with 50-GHz channel spacing. In addition, due to the narrow bandwidth of the modulation format provided, multiplexers or interleavers that are used to reduce the crosstalk in the transmitters or add ports can be avoided, which serves to reduce the total cost of system embodiments according to the invention. Furthermore, the sensitivity of NB-DPSK is much improved compared to optical duobinary, while being similar to DPSK and Partial-DPSK. At the same time a NB-DPSK system with a Polarization Mode Dispersion (PMD) compensator can tolerate more PMD than a DPSK system with a PMD compensator.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the present invention, and wherein:

FIG. 1 is a block diagram of an exemplary optical transmission system employing Narrow-Bandwidth Differential-Phase-Shift-Keyed (DPSK) (NB-DPSK) for at least one channel;

FIG. 2 is a block diagram of an exemplary embodiment of a NB-DPSK transmitter; and

FIG. 3 is a block diagram of an exemplary embodiment of a NB-DPSK receiver.

### DETAILED DESCRIPTION

Various example embodiments will now be described more fully with reference to the accompanying figures in which like numbers refer to like elements throughout the description of the figures.

Specific structural and functional details disclosed herein are merely representative for purposes of describing example embodiments. Example embodiments may, however, be embodied in many alternate forms and should not be construed as limited to only the embodiments set forth herein.

It will be understood that, although the terms first, second, etc. may be used herein to describe various elements, these elements should not be limited by these terms since such terms are only used to distinguish one element from another. For example, a first element could be termed a second element, and, similarly, a second element could be termed a first element, without departing from the scope of example embodiments.

As used herein this description, the term “and” includes any and all combinations of one or more of an associated list of items, and the singular forms “a”, “an” and “the” are intended to include the plural forms as well, unless the context clearly indicates otherwise. It will be further understood that the terms “comprises”, “comprising,”, “includes” and “including”, when used herein, specify the presence of stated features, integers, steps, operations, elements, and components, but do not preclude the presence or addition of one or more other features, integers, steps, operations, elements, components, and groups thereof.

It will be understood that when an element is referred to as being “connected” or “coupled” to another element, it can be directly connected or coupled to the other element with intervening elements present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent”, etc.).

Unless otherwise defined, all terms (including technical and scientific terms) used herein have the same meaning as commonly understood by one of ordinary skill in the art to which example embodiments belongs. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

It should also be noted that in some alternative implementations, the functions/acts noted may occur out of the order noted in the figures. For example, two figures/acts shown in succession may in fact be executed substantially concurrently or may sometimes be executed in the reverse order, depending upon the functionality/acts involved.

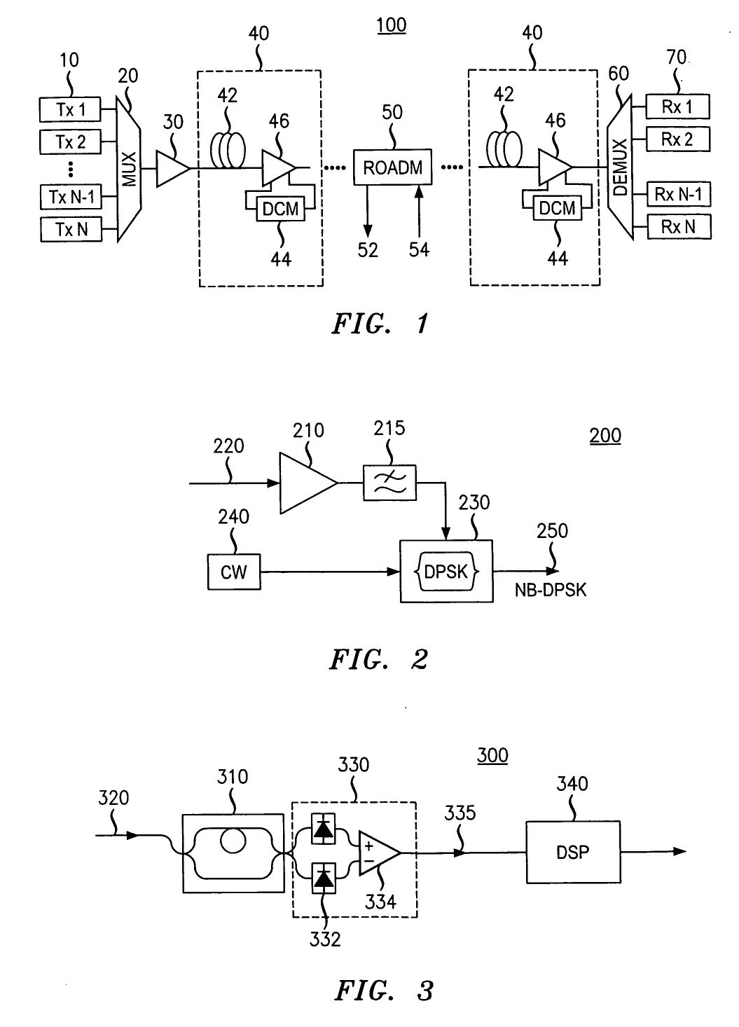

FIG. 1 is a block diagram of an exemplary optical transmission system 100. The exemplary optical transmission system employs for at least one channel Narrow Bandwidth Differential-Phase-Shift-Keying (DPSK) (NB-DPSK) as described below. In FIG. 1, a plurality of transmitters 10 are coupled to multiplexer 20 to produce a wavelength-division-multiplexed (WDM) signal that includes at least one modulated channel. At least one of the modulated channels is NB-DPSK. Transmitter 1 through transmitter N (10) may each provide a modulated channel to multiplexer 20.

Each of the transmitters need not provide a NB-DPSK channel. That is, at least one of the transmitters provides a NB-DPSK channel. For example, others of the modulated channels that may be provided may be Polarization-Division-Multiplexed (PDM), phase modulated, Quadrature Amplitude Modulated (QAM), and some combination thereof. For example, one of the modulated channels may be a PDM-QAM channel. Further, some transmitters may generate on-off keying (OOK) channels and some transmitters may generate phase modulated channels such that the WDM channels are combinations of OOK channels and phase modulated channels. For instance, the optical communication system may be a hybrid transmission system in which 40-Gb/s PDM-QPSK signals propagate together with 10-Gb/s OOK channels.

The WDM signal from the multiplexer 20 is amplified by amplifier 30, which may be an Erbium doped fiber amplifier (EDFA). From the amplifier, the WDM signal is directed to transmission fiber span 40. Each fiber span 40 may include a length of transmission fiber 42, followed by an inline dispersion compensation module (DCM) 44 for dispersion compensation to compensate the WDM signal and thereby suppress impairments, such as self-phase modulation (SPM) and inter-channel cross phase modulation (XPM). Such compensation may also include amplification by amplifier 46.

After traversing one or more fiber spans, the WDM signal may be provided to a reconfigurable optical add drop multiplexers (ROADM) 50. At the ROADM, one or more channels may be dropped 52, one or more channels may be added 54, or some combination of channel dropping and adding may be performed. From the ROADM, the WDM signal again traverses a transmission fiber span 40 in order to traverse the optical transmission system before arriving at demultiplexer 60. The demultiplexer 60 separates the WDM signal into a plurality of individual channels. Each individual channel is provided to a receiver 70 for decoding of the data information of the signal stream. A receiver, each one of receiver 1 through receiver N 70, may be a coherent detection receiver or direct detection receiver for decoding an individual channel. While only a single ROADM and single fiber span before and after the WDM signal arrives at the ROADM is illustrated in FIG. 1, the optical network 100 may include a plurality of ROADMs 50 and a plurality of transmission fiber spans 40 between each ROADM.

One of the transmitters 10 (e.g., Tx 1) generates a NB-DPSK channel. A corresponding receiver 70 for the NB-DPSK channel (e.g., Rx 1) decodes the data transmitted on the NB-DPSK channel. The NB-DPSK transmitter uses driver/s and modulator with bandwidth about a half of the bit rate to generate a NB-DPSK signal. In one embodiment, the combined bandwidth of the driver/s and modulator is about a quarter of the bit rate of the electrical binary signal provided to the transmitter. In another embodiment, the bandwidth of the NB-DPSK signal is about a quarter of the bit rate of the electrical binary signal provided to the transmitter. At the corresponding receiver, a DPSK receiver is used to detect the signal, where a delay line interferometer (DLI) with a length difference between the two paths less than approximately a bit period is used to demodulate the NB-DPSK signal. The DPSK receiver may be a partial DPSK receiver.

FIG. 2 is a block diagram of an exemplary embodiment of a NB-DPSK transmitter. The exemplary transmitter 200 includes an amplifier 210 that accepts as input a first electrical binary signal 220 with a bit rate R. An electrical filter 215 may be included to narrow the bandwidth of the first electrical binary signal. While the first binary signal is filtered after amplification in the illustrated exemplary embodiment, in other embodiments, the electrical filter may be inserted before the amplifier to pre-filter the first binary signal before amplification. The first binary signal after amplification, and optionally pre- and/or post-filtering, is used to drive a DPSK modulator 230. Continuous wave (CW) light generator 240 provides CW light to the DPSK modulator. The modulator utilizes the amplified output of the amplifier and the CW light to generate an NB-DPSK optical signal 250. In one embodiment, the combined bandwidth of the driver/s and modulator is less than approximately a half of a bit rate of a received signal 220. That is, the NB-DPSK optical signal 250 has bandwidth less than approximately a half of a bit rate of the received signal 220. In another embodiment, the combined bandwidth of the driver/s and modulator is less than approximately a quarter of a bit rate of a received signal 220

Thus in one embodiment, the amplifier 210 of the transmitter 200 has corresponding bandwidth so as to provide an amplified electrical signal having a bandwidth less than approximately one half or one quarter respectively of the bit rate of the input electrical binary signal. The narrowing of the signal bandwidth may also be provided by the electrical filter 215. For example, at the transmitter, a first signal 220 with bit rate of R may be amplified by an electrical amplifier 210 with a bandwidth less than approximately R/2. The first signal is an electrical binary signal. The first signal may also be filtered such that the combined bandwidth of the amplifier and filter is R/2. The amplified electrical signal is used to drive a Differential-Phase-Shift-Keyed (DPSK) modulator 230 with a bandwidth larger than R/2.

In another exemplary transmitter, the first signal 220 with bit rate of R may be amplified by an electrical amplifier 210 without narrowing the bandwidth and the DPSK modulator 230 have a bandwidth of less than approximately R/4 so as to generate a NB-DPSK optical signal having a bandwidth of less than approximately R/4. In other embodiment, the combined bandwidth of the amplifier, optional filter and modulator is and less than approximately R/2 or R/4.

In one embodiment, the modulator may be a Mach-Zehnder modulator that is biased at null and driven by the electrical signal with peak to peak voltage Vₚₚ=2V_{π}. V_{π} is a voltage that generates π phase shift between arms of the modulator. The input of the modulator is continuous wave (CW) light and an electrical binary signal for transmission and the output of the modulator is an optical NB-DPSK signal. The transmitter may also include an encoder.

As illustrated in FIG. 1, the optical NB-DPSK signal from the NB-DPSK transmitter may be multiplexed with one or more output signals from one or more other transmitters to generate a Wavelength Division Multiplexed (WDM) optical signal. The WDM optical signal then traverses an optical transmission system including transmission fiber spans and ROADMS to be demultiplexed at a demutiplexer. The transmitted optical NB-DPSK signal that has been demultiplexed is provided to a DPSK receiver for reception of the NB-DPSK signal.

FIG. 3 is a block diagram of an exemplary embodiment of a NB-DPSK receiver 300. The exemplary NB-DPSK receiver receives and decodes a NB-DPSK signal. The NB-DPSK receiver includes a Differential-Phase-Shift-Keyed (DPSK) Delay Line Interferometer (DLI) 310 that accepts as input an NB-DPSK optical signal 320. The length difference between the two paths of the DLI demodulator is less than approximately one bit period. The signal may be detected by a 1 bit period DLI, but with degraded sensitivity as compared to a DLI with less than a 1 bit period between its arms. The NB-DPSK optical signal received from the transmitter is amplitude modulated but also includes phase information, thus permitting improved sensitivity in the detection of transmitted information.

The NB-DPSK receiver also includes a detector 330 configured to detect output of the DLI demodulator so as to form a corresponding electrical signal 335. The detector may include a pair of photodetectors 332 and a comparator 334. While a balanced detector is shown, the detector may be a balanced detector or may be a single-ended detector. The corresponding electrical signal 335 is then provided to a digital signal processor 340 which decodes transmitted data from the corresponding electrical signal.

The method employed by the transmitter includes receiving the optical signal at a Delay Line Interferometer (DLI), wherein a length difference between two paths of the DLI is less than approximately one bit period; and detecting output from the DLI with a detector to form a corresponding electrical signal. The corresponding electrical signal is then processing to decode transmitted data of the optical signal. Processing of the corresponding electrical signal may include at least one of sampling the electrical signal; performing compensation on the sampled electrical signal to address nonlinearities in the received optical signal; and identifying a received symbol based on the sampled electrical signal.

Various of the functions described above may be readily carried out via software, firmware, and/or hardware, such as a processor and/or processor means, which can include one or more microprocessors, integrated circuits, Field Programmable Gate Arrays (FPGA's), optical processor's, etc. acting under appropriate instructions embodied, e.g., in software, firmware, or hardware programming.

What is claimed is:

1. An optical communication system comprising:
a receiver configured to receive a Narrow-Band Differential-Phase-Shift-Keyed (NB-DPSK) optical signal, the receiver comprising:
a Delay Line Interferometer (DLI), wherein a length difference between two paths of the DLI is less than approximately one bit period; and
a detector configured to detect output of the DLI to form a corresponding electrical signal.

2. The optical communication system of claim 1 wherein the NB-DPSK optical signal has bandwidth less than approximately one-half of a first bit rate of a transmitter from which the NB-DPSK optical signal is received.

3. The optical communication system of claim 1 wherein the receiver further comprises:
a processor adapted to decode transmitted data from the corresponding electrical signal.

4. The optical communication system of claim 1 wherein the DLI is a Partial Differential-Phase-Shift-Keyed (PDPSK) DLI.

5. The optical communication system of claim 1 wherein the detector is a balanced detector or a single-ended detector.

6. The optical communication system of claim 1 further comprising:
a transmitter, the transmitter accepting a first input signal having a first bit rate, the transmitter including
an amplifier configured to amplify the first input signal; and
a DPSK modulator configured to be driven by the first input signal after amplification to output the Narrow-Band DPSK optical signal, the NB-DPSK optical signal having bandwidth less than approximately one-half of the first bit rate.

7. The optical communication system of claim 6 wherein the transmitter further includes
an electrical filter disposed to filter the first input signal before of after amplification, and wherein the electrical bandwidth of the transmitter is less than approximately one-quarter of the first bit rate.

8. A method of optical communication comprising:
receiving a Narrow-Band Differential-Phase-Shift-Keyed (NB-DPSK) optical signal at a Delay Line Interferometer (DLI), wherein a length difference between two paths of the DLI is less than approximately 1 one bit period; and
detecting output of the DLI with a detector to form an electrical signal.

9. The method of claim 8 further comprising:
processing the electrical signal to decode a transmitted data.

10. The method of claim 9 wherein said processing comprises:
sampling the electrical signal; and
identifying a received symbol based on the sampled electrical signal.

11. The method of claim 10 wherein said processing further comprises:
performing compensation on the sampled electrical signal to address nonlinearities in the received optical signal.

12. The method of claim 8 wherein bandwidth of the NB-DPSK optical signal is less than approximately one-half of a first bit rate of a transmitter from which the NB-DPSK optical signal is received.

13. The method of claim 8 further comprising:
obtaining a first signal having a bit rate of R;
amplifying the first signal by an amplifier;
driving a modulator with the first signal after said amplifying so as to output the NB-DPSK optical signal, wherein the NB-DPSK optical signal has a bandwidth of less than approximately R/2.

14. The method of claim 13 wherein the bandwidth of the NB-DPSK optical signal is less than approximately R/4.

15. The method of claim 13 further comprising filtering the first signal.

16. The method of claim 13 wherein the modulator is a Mach-Zehnder Differential-Phase-Shift-Keyed (DPSK) modulator.

17. The method of claim 13 wherein the modulator is biased at null and wherein the amplified signal has a peak to peak voltage Vₚₚ=2 V_{π}, wherein V_{π} is a voltage that generates π phase shift between arms of the modulator.

18. The method of claim 8 further comprising
demultiplexing a Wavelength Division Multiplexed (WDM) optical signal to obtain a plurality of optical signals, at least one of the optical signals the Narrow-Band Differential-Phase-Shift-Keyed (NB-DPSK) optical signal.

19. An optical communication system comprising:
a Differential-Phase-Shift-Keyed (DPSK) receiver configured to detect a Narrow-Band Differential-Phase-Shift-Keyed (NB-DPSK) optical signal, the DPSK receiver comprising:
a DPSK demodulator having a path length difference of less than approximately a bit period, the DPSK demodulator configured to demodulate the NB-DPSK optical signal.

20. The optical communication system of claim 19 further comprising:
a transmitter configured to accept a first input signal having a first bit rate, the transmitter including
an amplifier configured to amplify a first input signal; and
a DPSK modulator configured to be driven by the first signal after amplification to output the Narrow-Band DPSK optical signal, the NB-DPSK optical signal having bandwidth less than approximately one-half of the first bit rate.
